(19) United States
(12) Patent Application Publication
(10) Pub. No.: US 2014/0143181 A1
(43) Pub. Date: May 22, 2014

(54) SYSTEMS AND METHODS FOR PROVIDING NETWORK OBJECTS THAT MOVE FREELY, EXPAND KNOWLEDGE AUTONOMOUSLY, AND COMMUNICATE WITH USERS OF A NETWORK

(71) Applicant: Kay Uwe Rehberg, Amberg (DE)

(72) Inventor: Kay Uwe Rehberg, Amberg (DE)

(21) Appl. No.: 13/679,227

(22) Filed: Nov. 16, 2012

(51) Int. Cl. G06N 99/00; G06N 3/02

(52) U.S. Cl. CPC G06N 99/005; G06N 3/02
USPC 706/12; 706/15

(57) ABSTRACT

A method for providing information to a user of a computer in a network of computers via an object program which moves freely about the network to access and store data relating to knowledge attributes of property fields available in the network, expanding autonomously the knowledge attributes over time as the object moves about the network, and communicating the information of the knowledge attributes to and from the computers of requestors as requested.

### TECHNICAL FIELD

Aspects of the present disclosure relate to computing systems, and in particular, network systems.

### BACKGROUND

Complex computer programs, such as speech recognition programs for example, now exist, including by way of example WO 2004/079720, wherein these computer programs have certain attributable fields and have a self-learning function. Such programs are provided to a user with a basic set of property data, and as the program is used, it incorporates new terms, phrases, and the like, the same being input by the user, into the vocabulary of the program as new, additional property data.

In addition, software structures are also known, particularly so-called neural network software structures, which are able to reproduce the basic functions of at least subregions of the human brain, and as such can emulate the intelligence of a living being, an artificial companion (AC), at least in outline. The idea of stimulated beings in the virtual world presented as communication partners—so called avatars—which are virtual representatives of real people, is already known, particularly from films or computer games. However, these are used increasingly in other areas, for example in the context of computer-based communication and virtual environments.

At the same time, today in the era of electronics there are numerous possibilities to access information via public digital public networks, particularly via the Internet. In this regard, search engine services, such as Google and Yahoo, or open encyclopedias such as Wikipedia and the like, for example, are particularly significant. These services offer a certain amount of information upon the input of keywords. The Internet in particular gives users the opportunity to access and use any type of information available in electronic form at any time and nearly any place.

Computer viruses spread through the Internet relatively uncontrolled. Computer viruses are also known which fix computers infected with malicious software at the behest of governments, and in the course of this activity travel independently through the network. So called sniffer programs already search through networks at the present time in an independent manner. Such software can intercept the data traffic of a network, and record, display, and optionally analyze the same.

At this time, certain services can be accessed directly via the Internet by a user in an automated fashion, including the execution of computer translations, automated stock transactions, automated sales at Internet auction sites, etc., for example. In these cases, however, the service is always activated by a particular user in a discrete case.

### SUMMARY

One aspect of the present disclosure involves a system for using a network. The system includes at least one processor to generate one or more objects, each object comprising a plurality of property fields, each property field of the plurality of property fields including one or more knowledge attributes. The processor is further configured to initiate the one or more objects to move freely throughout a network. The one or more objects comprise modules configured to expand the one or more knowledge attributes for each property field while moving throughout the network and communicate the information of the knowledge attributes to a remote device.

Aspects of the present disclosure include a non-transitory computer readable storage media storing a program comprising instructions which when executed by a computer connected to a network of computers implements a method. The method includes accessing by an administrator of the computer in the network to initiate a program which acquires information throughout the network to provide the information to the requestors at any one of the computers having access to the network, comprising providing the program which includes an object having a mobility function, a self-learning function, and a communication function, said object having a plurality of property fields comprising the information. The objects include moving freely about the network to access and store data relating to knowledge attributes of the property fields available in the network, thereby providing the mobility function, expanding autonomously the knowledge attributes in the property fields of the object over time as said object moves about the network, thereby providing the self-learning function. The objects further include communicating the information of the knowledge attributes in the property fields to and from the computers of the requestors as requested, thereby providing the communication function.

Aspects of the present disclosure include methods for using a network. The method includes accessing by an administrator of the computer in the network to initiate a program which acquires information throughout the network to provide the information to the requestors at any one of the computers having access to the network, comprising providing the program which includes an object having a mobility function, a self-learning function, and a communication function, said object having a plurality of property fields comprising the information. The objects include moving freely about the network to access and store data relating to knowledge attributes of the property fields available in the network, thereby providing the mobility function, expanding autonomously the knowledge attributes in the property fields of the object over time as said object moves about the network, thereby providing the self-learning function. The objects further include communicating the information of the knowledge attributes in the property fields to and from the computers of the requestors as requested, thereby providing the communication function.

### BRIEF DESCRIPTION OF THE FIGURES

Aspects of the present disclosure may be better understood and its numerous Objects, features, and advantages made apparent to those skilled in the art by referencing the accompanying drawings. It should be understood that these drawings depict only typical embodiments of the present disclosure and, therefore, are not to be considered limiting in scope.

FIG. 1 is an example computing environment for providing Objects, according to aspects of the present disclosure.

FIG. 2 is a block diagram of a processing device, according to aspects of the present disclosure.

FIG. 3 is an example process for moving Objects within a network, according to aspects of the present disclosure.

FIG. 4 is a block diagram of an example Object, according to aspects of the present disclosure.

### DETAILED DESCRIPTION

Aspects of the present invention disclose systems and methods for allowing one or more applications, applets, processes, functions, etc., referred to herein as “Objects”, to move dynamically throughout a computing network and/or system, such as the Internet, Intranet, etc., or the like. An Object represents an application, module, applet, process, or any type of executable instruction that functions, behaves, and/or executes similar to a physical, real-world object while moving throughout a given network, such as the Internet.

Objects may move freely throughout a network comparable to a computer virus/computer worm moving throughout a network with respect to its degree of freedom in movement. However, the Objects do not modify any data without permission, and the Objects do not infect any data with code, as would the software of a traditional computer virus or worm. More importantly, the ability of the Objects to move freely throughout a network allows the Objects to find large amounts of information sources and/or communication interfaces, and subsequently download data or exchange information, if suitable, without infecting the various information sources or communication interfaces, such as with malicious code. The behavior of the Objects proceeds in accordance with the specific program, functions, and/or processes of each respective Object and with no direct influence of its creator. Stated differently, the Objects move throughout a given network similar to an actual user in the Internet. In contrast to a computer virus or a computer worm, the Object is able to execute itself. For example, the Object may relocate itself from one location on a network to another, different location on the network. As another example, Objects may duplicate and/or multiply their own source code.

According to various aspects, it may be expedient for Objects to autonomously generate new keywords, values, and/or modifications of their own source code, similar to a computer virus. To avoid being detected by emulation, some viruses rewrite themselves completely each time they are to infect new executables. Viruses that utilize this technique are said to be metamorphic. In order to fulfill the evolution function, programs which fulfill the above task autonomously rewrite their program to increase complexity and performance rather than to hide their existence, as in the case of a virus. Accordingly, a modification to the programming of a given Object by means of modification of its source code may be necessary, as new programs and/or functionalities may be integrated into the Object during the course of the Object's evolution.

Additionally, target files and/or contacts of Objects moving throughout a network, such as the Internet or the DS, may be autonomously selected and controlled by the Object. Data elements pre-specified in the Object for the purpose of selection and control of the target files in the Internet or in the DS are compared to target data elements, and a selection and/or transfer of data occurs according to a predetermined agreement.

Aspects of the present disclosure allow access to property fields of Objects, which will be described in further detail below. The selection of such property fields may be determined by a user of the Object. Additionally, the election of interesting content or contacts and communication nodes by the Object while moving freely throughout a given network, such as the Internet or in the DS, can occur by means of special inputs, such as keywords. For example, if a property field is oriented toward the provision of translations from German into English, the selection can be made by comparison, for example, with keywords such as “Ubersetzung,” [“translation”] “translate,” or even the names of services such as “Leo,” “Google,” “Linquee,”[sic: “Linguee”] etc. Contacts could be similar programs, information services such as telephone books, or optionally, real users.

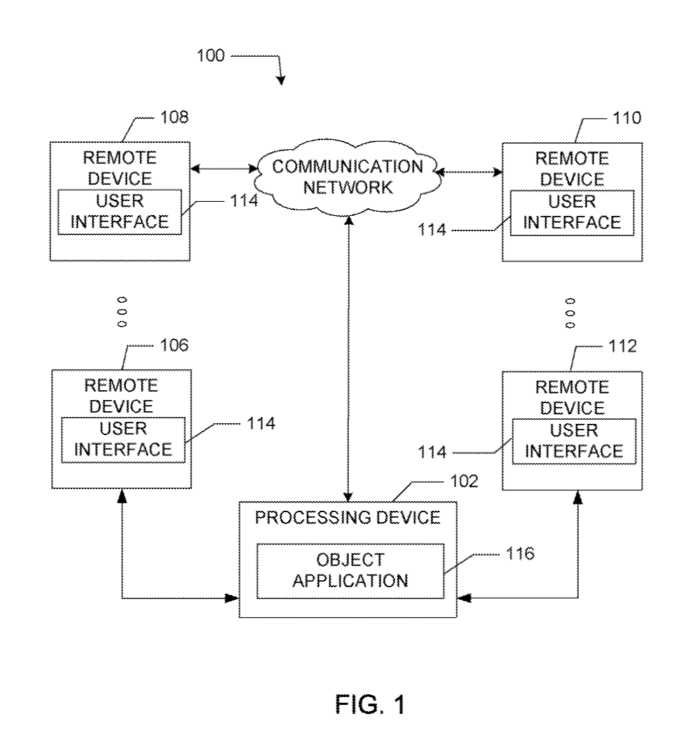

FIG. 1 illustrates an example computing environment 100 for facilitating the movement of one or more Objects through a network, such as the Internet, Intranet, or any type of network. Computing environment 100 may include a processing device 102 capable of initiating and managing such Objects within and/or otherwise throughout the network. The processing device 102 may be a personal computer, work station, server, mobile device, mobile phone, tablet device, processor, and/or other processing device capable of implementing and/or executing server processes, software, applications, etc. The processing device 102 may include one or more processors that process software or other machine-readable instructions and may include a memory to store the software or other machine-readable instructions and data. The memory may include volatile and/or non-volatile memory. Additionally, the processing device 102 may also include a communication system to communicate via a wireline and/or wireless communications, such as through the Internet, an intranet, an Ethernet network, a wireline network, a wireless network, a mobile communications network, and/or another communication network, such as communications network 118. The processing device 102 may include a user-interface (UI) (not shown) for a user to provide input and may include a display (not shown) such as a computer monitor, liquid crystal display, for viewing data and/or input forms, and any combination of input/output devices (not shown), such as a keyboard or a pointing device (e.g., a mouse, trackball, pen, or touch pad), speaker, and/or any other type of device for receiving input.

The computing environment 100 may include one or more remote devices 106-112 that may allow users to interact with Objects moving throughout a given network. The remote devices 106-112 may be a personal computer, work station, server, mobile device, mobile phone, tablet device, processor, and/or other processing device. Each remote device 106-112 may include one or more processors that process software or other machine-readable instructions and may include a memory to store the software or other machine-readable instructions and data. The memory may include volatile and/or non-volatile memory. Additionally, each remote device 106-112 may include a communication system to communicate via a wireline and/or wireless communications, such as through the Internet, an intranet, an Ethernet network, a wireline network, a wireless network, a mobile communications network, and/or another communication network, such as communications network 118.

Additionally, each remote device 106-112 may include a user-interface (UI) (not shown) for a user to provide input and may include a display (not shown) such as a computer monitor, liquid crystal display, for viewing data and/or input forms, and any combination of input/output devices (not shown), such as a keyboard, or a pointing device (e.g., a mouse, trackball, pen, or touch pad), speaker, and/or any other type of device for receiving input.

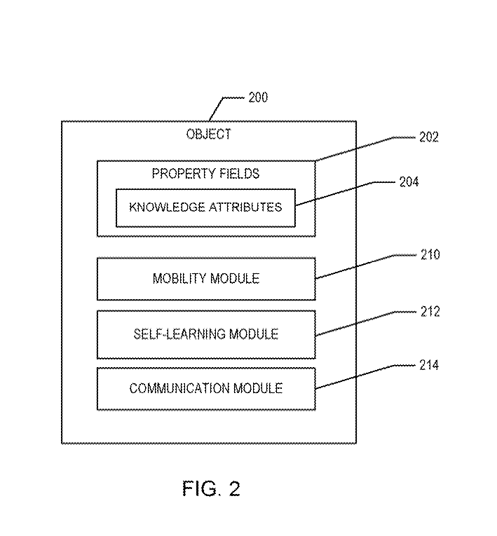

The processing device 102 may execute an object application 116 that, as will be described in further detail below, may generate one or more Objects capable of moving freely throughout a network. For example, according to one embodiment, the object application 116 may generate one or more Objects that may move throughout the Internet in a manner similar to a computer virus. FIG. 2 illustrates an example object 200 that may be defined by the object application 116. As shown, the object 200 includes a plurality of property fields 202. A property field represents a collection of data, rules, and/or standards corresponding to an ability of the object 200. For example, the object 200 may be capable of communicating—transmitting, sending, receiving, etc.—various pieces of information while moving throughout the Internet. Accordingly, the object 200 may include and/or require various property fields articulating how the Object may specifically implement such communication or communication protocols. As another example, the property fields of the object 200 may represent the property of a translator, which is able to execute translations from the German into the English language, or the opposite. Each property field may include one or more knowledge attributes 204.

The knowledge attributes may be represented in the form of a matrix (attribute-value) table, referred to as information systems. Within a matrix table, each row may represent a knowledge attribute (e.g. signal, charge, client, case, etc.) Columns in the table may represent attributes means features or properties characterizing the knowledge attributes. For example, rough set methods and applications are known to manage knowledge discovery, spatial reasoning, data reduction methods, concurrent systems analyses and synthesis, data analyses, and data mining, etc. While FIG. 2 illustrates an example of only one single Object, it is contemplated that any number of Objects may be generated by the object application 116.

The Objects defined by the object application 116 may be modeled or otherwise designed to emulate various real live physical objects. For example, in one embodiment, the Objects may be designed to emulate a cat. In particular, the cat object represents an artificial avatar looking like a cat—details of the appearance may be determined by costume. The cat is allowed to move freely between various processing devices. The cat object is implemented to function in a manner similar to a cat. Stated differently, the cat object may include various functionalities comparable to the behaviors of a physical cat and further may allow a user to interact with the cat object in a manner similar to a person interacting with a real cat.

The cat object may include functionalities allowing the Object to rearrange folders on a computer desktop. As another example, the cat object may include functionalities equating to a “virtual scratch” on the desktop, etc. The cat object may include functionality to be relocated from one device on the network to another. Such behavior by the cat object may be interpreted by a user and the cat playing with the user, disappearing, etc. Various external software applications, applets, interfaces, APIs, etc., may be integrated with or otherwise executed in conjunction with the logical components of the present disclosure to generate and/or implement objects. For example, such components may include: natural language processors, speech recognition software, artificial intelligence software, and the like.

In another example, the various Objects may be designed to emulate an administrative assistant. Specifically, such an administrative object may look similar to an artificial avatar looking like a male or female human—details of the appearance may be determined by costume. The administrator object may include functionality allowing it to move freely between various devices on the network, such as the remote devices 106-112. Additionally, the administrator object may include various functionalities emulating a real-life assistant, such as being able to process documents in Word, prepare standard reports and proposal documents as required, photocopy documents, process and distribute faxes and e-mail as required, download documents, etc. Other various functionalities may also be included.

In one particular embodiment, the administrator object may act like a system operator granted certain administrative privileges for overseeing the operation of a computing system, such as a server, or other processing device. Accordingly, the administrative object may automatically insert or install new software into the overall system. The administrator object may enable the sharing of various files or applications, such as shareware and/or freeware, and/or other files. All of such decisions are based on, or identified by an information system (i.e. matrix table).

Referring again to FIG. 1, while aspects of the present disclosure have been described as being performed using multiple devices within a computing environment, such as computing environment 100, it is contemplated that such aspects may be performed locally, using only a single device, such as the processing device 102, and in such cases the remote device(s) 106-112 and any corresponding software/hardware components are integrated into or are otherwise in direct connection with the processing device 102.

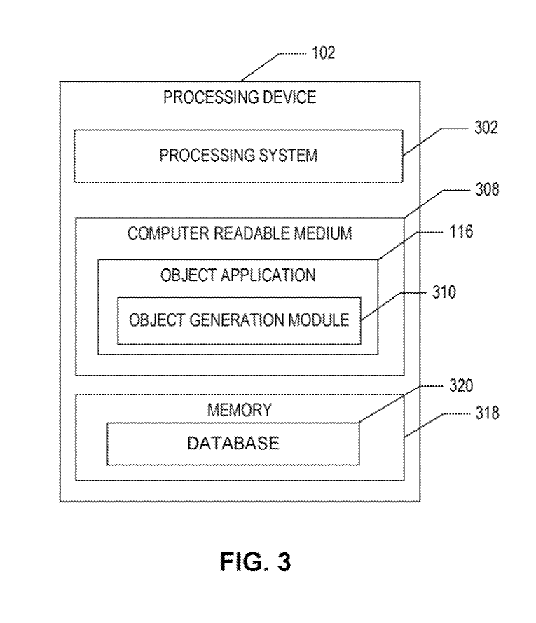

FIG. 3 is a block diagram illustrating the processing device 102 according to aspects of the present disclosure. The processing device 102 includes a processing system 302 that may be used to generate one or more Objects. The processing system 302 may be in communication with a memory 318. The memory 318 may include volatile and/or non-volatile memory, and provides a database 320 to store data. According to one aspect, database 320 is a general repository of data including, but not limited to, monitoring data corresponding to Objects. The database 320 may include memory and one or more processors or processing systems to receive, process, query and transmit communications and store and retrieve data. In another aspect, the database 320 may be a database server. In one particular embodiment, the database may be a content management database system and/or server.

The processing device 102 may include a computer readable medium (“CRM”) 308, which may include computer storage media, communication media, and/or another available computer readable medium that may store executable instructions to implement the object application 116 and/or associated functions, processes, etc. CRM 308 may include non-transient computer storage media and communication media. By way of example and not limitation, computer storage media includes memory, volatile media, non-volatile media, removable media, and/or non-removable media implemented in a method or technology for storage of information, such as machine/computer-readable/executable instructions, data structures, program modules, or other data. Communication media includes machine/computer-readable/executable instructions, data structures, program modules, or other data. Generally, program modules include routines, programs, instructions, Objects, components, data structures, etc., that perform particular tasks or implement particular abstract data types. For example, as illustrated, CRM 308 may include or otherwise store an object generation module 310 of the object application 116.

Referring now to FIGS. 1-4, in one particular embodiment, the processing device 102 may launch, run, execute, interpret, or otherwise perform the logical instructions and/or processes of the object application 116, such as process 400, which depicts an example method and/or process for managing the movement of Objects throughout a computing network.

Process 400 begins with generating at least one Object for movement throughout a network (operation 402). As illustrated in FIG. 3, the object generation module 310 may generate one or more Objects. Each Object, as described above, may be an application, applet, etc., capable of moving throughout a computing network. FIG. 2 is an example block diagram of the object 200, which represents an exemplary Object that may be generated by the generation module 310. As shown, the object 200 includes a mobility module 210, a self-learning module 212, and a communication function module 214, all of which may be used to allow the object 200 to move throughout the network and acquire information to be communicated to users.

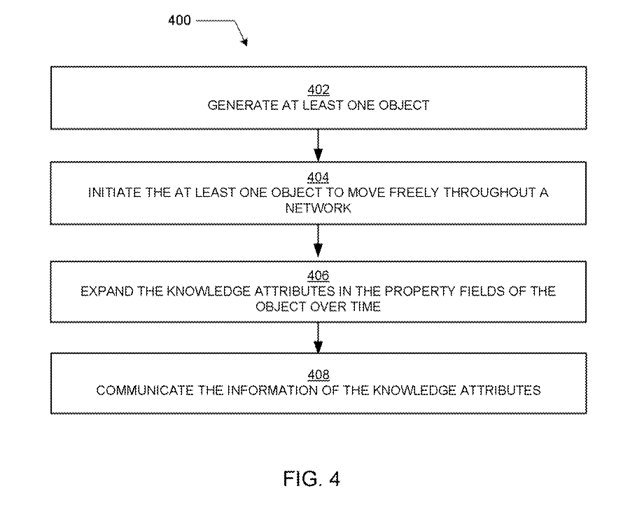

Referring again to FIG. 4, any generated Objects may be initiated to move freely throughout the network (operation 404), for example, by the generation module 310 of FIG. 3. In particular, the generation module 310 may activate and/or otherwise initiate the mobility function 210 of the Object. In one embodiment, once initiated, the Object may move throughout the Internet in a manner comparable to a virus or worm. While the Object moves throughout the network, the Object may access various resources, such as applications, data sources, and/or communication interfaces and protocols, as a real user would when attempting to access various computing resources on a network. Thus, movement should not be construed to only mean the movement of the Object(s) to other storage media, but rather free access to any and all available sources, application, and communication interfaces, similar to that of an actual user. Accordingly, the Objects may initiate contact to other sources in a network, for example the Internet, by utilizing the Object's own values (property fields), keywords, or keyword combinations.

A keyword represents a kind of code used to initiate a contact. To guarantee the security of a distributed system, proper authentication and authorization must be performed. An authorization may include the location of a subject as an attribute to identify the subject. The keyword is used to establish that the contact is established between the right subjects.

As soon as an information source is located in this manner, the Objects may test the contents of the information source using data already available, for example using a relevance test. If the result of the test is positive, the Objects incorporate the information into the relevant property field. For example, an Object can find a particular location in the Internet by means of a keyword in the case of the translator example. The Object then compares the contents of this information item and supplements its own property field if the newly found information item contains additional semantic content related to a word in the other language or in a phrase. In this way, the property field of the Object becomes increasingly more comprehensive in a manner comparable to a “learning life form.”

Referring again to FIG. 4, once an object begins freely moving throughout a network, one or more property fields of the Object may be expanded (operation 406). For example, referring to FIG. 2, the self-learning function module 210 may gather, obtain, and/or otherwise receive information to expand the various property fields of the Object.

For example, as described above, an information system may consist of a matrix or table containing properties, attributes, features, etc. Assume a user of an administrative object has the habit of entering their office at the same time everyday. A row in the matrix may describe when the user is available in the office in the morning as a property field. If the user adds an additional job with a new different office location, and only comes into the new office in the evening, the administrative object may learn such habits and write new data to the property field to include such habits of the user. In particular, the administrative object may obtain data describing the devices that the user may be using when engaging in such habits, the type of device, access channels, etc.

Once one or more property fields have been expanded, the knowledge attributes of the property fields may be communicated, for example to a user (operation 408). For example, the communication module 212 may provide the knowledge attributes to one or more of the remote devices 106-112 for access. Such a movement is expressed particularly by the free selection and determination of the type of communication interface and/or the message forwarding to the user, such as, by way of example, a mobile telephone, computer based in a vehicle, etc. Likewise, communication between the object and other objects having the ability to communicate is also possible by means of the communication interface of the object. For example, the Open Systems Interconnection (OSI) model may be a possible communication protocol for the exchange of information. Thus, if an object has achieved a certain “state of knowledge,” it can provide its state of knowledge to an unlimited set of users, such as remote devices 106-112, either upon request by the respective user or as a part of a permanent user agreement, or in another manner.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method of using a network of computers, comprising:
accessing by an administrator of one computer in the network to initiate a program which acquires information throughout the network to provide the information to requestors at any one of the computers having access to the network, comprising:
providing the program which includes an object having a mobility function, a self-learning function, and a communication function, the object having a plurality of property fields comprising the information, said object comprising:
moving freely about the network to access and store data relating to knowledge attributes of the property fields available in the network, thereby providing the mobility function,
expanding autonomously the knowledge attributes in the property fields of the object over time as said object moves about the network, thereby providing the self-learning function; and
communicating the information of the knowledge attributes in the property fields to and from the computers of the requestors as requested, thereby providing the communication function.

2. The method according to claim 1, wherein the object moves in the manner of a computer virus or a computer worm with respect to its manner of proliferation in the Internet or in the DS.

3. The method according to claim 1, wherein the object orients itself in its proliferation through the Internet or the DS for the purpose of expanding its property fields on the basis of keywords.

4. The method according to claim 1, wherein the object autonomously generates new keywords, its own values, and modifications to its own source code.

5. A non-transitory computer readable storage media storing a program comprising instructions which when executed by a computer connected to a network of computers implements a method comprising:
accessing by an administrator of the computer in the network to initiate a program which acquires information throughout the network to provide the information to the requestors at any one of the computers having access to the network, comprising:
providing the program which includes an object having a mobility function, a self-learning function, and a communication function, said object having a plurality of property fields comprising the information, said object comprising:
moving freely about the network to access and store data relating to knowledge attributes of the property fields available in the network, thereby providing the mobility function,
expanding autonomously the knowledge attributes in the property fields of the object over time as said object moves about the network, thereby providing the self-learning function; and
communicating the information of the knowledge attributes in the property fields to and from the computers of the requestors as requested, thereby providing the communication function.

6. The media according to claim 5, wherein the object actively or passively provides or receives the information of the property field for use of the same.

7. The media according to claim 5, wherein the object based on a data processing program simulates a neural network as control software.

8. The media according to claim 5, wherein the object moves in the manner of a computer virus or a computer worm with respect to its manner of proliferation in the Internet or in the DS.

9. The media according to claim 5, wherein target files and/or contacts of the object in the Internet or in the DS can be autonomously selected and controlled by the object.

10. The media according to claim 9, wherein data elements pre-specified in the object for the purpose of selection and control of the target files in the Internet or in the DS are compared to target data elements, and a selection and/or a transfer of data occurs according to a pre-determined agreement.

11. The media according to claim 5, wherein properties of the property fields of the object can be accessed by a user when requested.

12. The media according to claim 5, wherein selection of the property fields can be determined by a user of the object.

13. A system for using a network comprising:
at least one processor to:
generate one or more objects, each object comprising a plurality of property fields, each property field of the plurality of property fields including one or more knowledge attributes; and
initiate the one or more objects to move freely throughout a network, the one or more objects comprising modules configured to:
expand the one or more knowledge attributes for each property field while moving throughout the network; and
communicate the information of the knowledge attributes to a remote device.

14. The system of claim 13, wherein the one or more object moves throughout the network in the manner of a computer virus or a computer worm.

15. The system of claim 13, wherein the one or more objects expands the one or more knowledge attributes for each property fields on the basis of keywords.

16. The system of claim 15, wherein the one or more objects autonomously generate new keywords and modifications to its own source code.

17. The system of claim 13, wherein the network is the Internet.

18. The system of claim 13, wherein the modules of the one or more objects are further configured to select one or more communication interfaces to communicate the information to the remote device.

19. The system of claim 13, wherein each objects of the one or more objects initialize communication of the information to the remote device by utilizing its corresponding plurality of property fields to locate information.
